(19) United States
(12) Patent Application Publication
(10) Pub. No.: US 2017/0109142 A1
(43) Pub. Date: Apr. 20, 2017

(54) SYSTEM AND METHOD TO BUILD A MOBILE APPLICATION

(71) Applicant: Cogitate Technology Solutions, Inc., Marietta, GA (US)

(72) Inventor: Arvind PremLal Kaushal, Kennesaw, GA (US)

(73) Assignee: Cogitate Technology Solutions, Inc., Marietta, GA (US)

(21) Appl. No.: 15/296,467

(22) Filed: Oct. 18, 2016

Related U.S. Application Data
(60) Provisional application No. 62/243,305, filed on Oct. 19, 2015.

(51) Int. Cl. G06F 9/44; H04L 29/08; H04W 4/18; H04L 29/06

(52) U.S. Cl. CPC G06F 8/34; H04L 67/42; H04L 67/02; H04L 67/34; H04W 4/18

(57) ABSTRACT

The present disclosure relates systems and methods for creation of a customized mobile application. In an aspect, the system receives one or more customization inputs from a user; automatically and dynamically retrieves at least one user information attribute from one or more servers that the system is operatively coupled with; verifies the received one or more customization inputs and the dynamically retrieved at least one user information attribute; creates at least one configuration file based on the verified one or more customization inputs and the dynamically retrieved at least one user information attribute; creates at least one web service file for configuration or hosting on a web/application server; and builds the at least one configuration file and the at least one web service file to generate and publish an executable file of the mobile application.

### TECHNICAL FIELD

The present disclosures relates to the field of mobile applications. More particularly, the present disclosures relates to systems and method for building and publishing customized mobile applications.

### BACKGROUND

Background description includes information that may be useful in understanding the present invention. It is not an admission that any of the information provided herein is prior art or relevant to the presently claimed invention, or that any publication specifically or implicitly referenced is prior art.

After the rapid evolution of computing devices such as personal computers, and later smart computing devices such as laptops, smart phones, tablets, the world is now moving at a faster pace. With the introduction of these devices, lot of improvements and advancements were executed on the hardware side, software side, and other segments e.g. communication protocols, networking mechanisms etc. with their step-by-step applicability in the development stages.

In earlier days, usage of computing devices and/or applications installed on these devices was designed mostly for scientific and financial calculations, however with the advancement and introduction of graphical user interface (GUI), computing devices have become a very common and integral part of modern life for all categories of users. Usability of these computing devices enables a user to perform various operations/functionalities under the control of different application programs.

Application software that most of the people can think of uses a computing system to perform special functions or provide entertainment functions beyond the basic operation of the computer itself. There are many different types of application software for varying range of tasks that can be performed with the modern computing devices. Application software can run as an independent application when installed on the computing device, and can be tailored for specific platforms or can be platform independent.

Mobile has affected more than just our digital operations, wherein it has also transformed our entire business sector and also had a larger impact on personal front of the user. It is becoming not only a new digital hub but also a link or a bridge to the physical world to make revolutionary changes to the way of doing business, and those who can quickly adapt to these changing user behaviour can attract today's mobile consumer faster and easily for business aspects. People who are quick to adapt these changes can get better, maximum and faster services in all those sectors, which are approached by them.

Smart devices including PDA, smart phones, and small-hand held computers are becoming more common for personal and other uses e.g. parcel delivery, service calls, advertisement, mass messaging, etc. The idea applied by various business firms to make their products and services reachable and available to every customer can be possible through these mobile devices and their capability to work with number of different applications that are installed for enabling and accessing different functionalities and services offered by them. Design and implementation of application software varies depending on complexity of the software and has special economic characteristics that make its design, creation, and distribution different from most of the other economic goods.

In past few years, innovative steps have been taken to design and implement an application or an application builder or an application maker (also interchangeably referred to as “app” or “app builder” hereinafter) that can be installed on any mobile device to produce a customized application software for a particular industry/business/academic domain e.g. insurance, school, courier services, banking sector, etc. However, these methodologies provide customization only through manual intervention, which is time consuming and error prone, and also demand more effort/cost for incorporating small changes in predesigned application software on the demand of customers/clients at a later stage i.e. after implementation. Such re-implementation also requires a wireless and Internet mode for transmitting the whole new updated application software reflecting a very tiny change. One reason why such issues arose was because all businesses and other entities needed more customized applications among their employees and customers for their respective business domains in terms of market competence to increase their mobile presence, which required hard coded applications that were needed to be built from scratch. Also, customized applications are not affordable by large number of small business holders and single entities due to higher cost to be invested for the development process, longer time durations generally needed for development of such applications, and availability of the technical person/IT programmer each and every time for incorporating some additional features or customized changes in the application build for execution of business activities. Instead of providing the business holders with satisfaction of having an easy way of doing business, the application software implementation and trend made their involvement more complex because of the high maintenance needed by application software to keep running for their businesses. Every time they need to hire a new IT firm or IT professional to debug their application software, web applications, sites, etc. gives them a hard time and diverts them from their core focus areas.

There is therefore a need in the art for a system and method for conceptualizing and structuring a new mobile application builder that allowing business firms, enterprises, and small entities to customize and build, publish, and maintain their application software quickly through a mobile application builder, without hiring any programmer to write/modify source code for the application software.

In some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise. Also, as used in the description herein, the meaning of abbreviated term “app” is application software unless the context clearly dictates otherwise.

### SUMMARY

The present disclosure relates to the field of mobile application builder. More particularly, the present disclosures relate to an application for building and publishing customized mobile applications, say for insurance agents in an instance.

In an aspect, the present disclosures relates to building a customizable/customized mobile application from a mobile application builder by receiving user inputs through a user interface of a computing device for creating an application, dynamically retrieving user related information from one or more servers, verifying user inputs and dynamically retrieved user related information, building the application if the received user inputs and the dynamically retrieved information is verified; and publishing the created application on an online store.

In an aspect, computing device can be a mobile phone, a smart phone, a tablet PC, a PDA, or any other like computing device that has a display that enables a user to enter inputs through a defined interface configured on the display. In another aspect, the user input/scan before selecting any or a combination of platform selection icon(s), business domain selection icon, country selection, language selection, insurance information, agent information, agent service location, among other like user inputs. User related information, on the other hand, can be dynamically retrieved from one or more servers via at least one network (such as LAN, WAN, Internet, among other possible networks).

In an aspect, user interface background color, themes, icon arrangements can be editable. In another aspect, building of the mobile application can include compilation of configuration files, and publishing of the application can include posting of the created application on an online store.

Various objects, features, aspects and advantages of the inventive subject matter will become more apparent from the following detailed description of preferred embodiments, along with the accompanying drawing figures in which like numerals represent like components.

### BRIEF DESCRIPTION OF THE DRAWINGS

In the Figures, similar components and/or features may have the same reference label. Further, various components of the same type may be distinguished by following the reference label with a second label that distinguishes among the similar components. If only the first reference label is used in the specification, the description is applicable to any one of the similar components having the same first reference label irrespective of the second reference label.

FIG. 1 illustrates an exemplary architecture for mobile application development and publication in accordance with an embodiment of the present disclosure.

FIG. 2 illustrates exemplary functional modules of an application builder in accordance with an embodiment of the present disclosure.

FIG. 3 illustrates an exemplary diagram depicting platform selection for application building in accordance with an embodiment of the present disclosure.

FIG. 4 illustrates an exemplary diagram depicting business domain selection in accordance with an embodiment of the present disclosure.

FIG. 5 illustrates an exemplary diagram depicting country and language selection for application development and functioning in accordance with an embodiment of the present disclosure.

FIG. 6 illustrates an exemplary diagram for depicting property insurance details entry screen in accordance with an embodiment of the present disclosure.

FIG. 7(A) illustrates an exemplary diagram showing agent's personal details screen in accordance with an embodiment of the present disclosure.

FIG. 7(B) illustrates an exemplary diagram showing agent service locations screen in accordance with an embodiment of the present disclosure.

FIG. 8 illustrates an exemplary diagram showing progress of compilation/building steps of customized application in accordance with an embodiment of the present disclosure.

FIG. 9 illustrates an exemplary diagram showing launched insurance application on an application store in accordance with an embodiment of the present disclosure.

FIG. 10 illustrates an exemplary flow diagram depicting steps involved in building an application in accordance with an embodiment of the present disclosure.

### DETAILED DESCRIPTION

The following is a detailed description of embodiments of the disclosure depicted in the accompanying drawings. The embodiments are in such detail as to clearly communicate the disclosure. However, the amount of detail offered is not intended to limit the anticipated variations of embodiments; on the contrary, the intention is to cover all modifications, equivalents, and alternatives falling within the spirit and scope of the present disclosure as defined by the appended claims.

Each of the appended claims defines a separate invention, which for infringement purposes is recognized as including equivalents to the various elements or limitations specified in the claims. Depending on the context, all references below to the “invention” may in some cases refer to certain specific embodiments only. In other cases it will be recognized that references to the “invention” will refer to subject matter recited in one or more, but not necessarily all, of the claims.

Various terms as used herein are shown below. To the extent a term used in a claim is not defined below, it should be given the broadest definition persons in the pertinent art have given that term as reflected in printed publications and issued patents at the time of filing.

The present disclosure relates to the field of mobile application builder. More particularly, the present disclosure relates to an application for building and publishing customized mobile applications, say for insurance agents in an instance.

In an aspect, the present disclosures relates to building a customizable/customized mobile application from a mobile application builder by receiving user inputs through a user interface of a computing device for creating an application, dynamically retrieving user related information from one or more servers, verifying user inputs and dynamically retrieved user related information, building the application if the received user inputs and the dynamically retrieved information is verified; and publishing the created application on an online store.

In an aspect, computing device can be a mobile phone, a smart phone, a tablet PC, a PDA, or any other like computing device that has a display that enables a user to enter inputs through a defined interface configured on the display. In another aspect, the user inputs can be for selecting any or a combination of platform selection icon(s), business domain selection icon, country selection, language selection, insurance information, agent information, agent service location, among other like user inputs. In an aspect, user related information (interchangeably referred to as “user inputs” or “user information”), on the other hand, can be dynamically retrieved from one or more servers via at least one network (such as LAN, WAN, Internet, among other possible networks). Such dynamically retrieved user information can include, for instance, insurance companies that a given agent is associated with, his/her relationship details with such insurance companies, plans being offered, among other like information.

In an aspect, user interface background color, themes, icon arrangements can be editable. In another aspect, building of the mobile application can include compilation of configuration files, and publishing of the application can include posting of the created application on an online store.

Embodiments of the present disclosure provide a mobile application builder that can create and publish a customized mobile application and bring application development down from the hands of IT professionals/programmers into the hands of a normal user. An object of the present disclosure and system/method is to authorize a normal mobile user, for example, an insurance agent to capture more customers with powerful, cross-platform application that the insurance agent can create from his/her own device without the knowledge of coding or expert designing skills. Mobile application builder (also interchangeably referred to as “app builder” or “application builder” hereinafter), enables an insurance agent or any other business owner who wishes to develop a mobile application to develop personalized/customized application for smartphones, tablets or any other computing device. The application builder can receive customization input such as logo, background color, theme, background image, application branding information, button colors, text colors, icon colors, and any other interface level options/features such as desired images, application icon(s), main page graphics, and other images, from a user. After receiving the customization input from the user, the application builder can verify essential inputs that may be required to check over the application distribution platform or Internet. For instance, it can be checked if the proposed logo, branding information does not conflict with some other existing application.

In an aspect, the application builder can generate one or more configuration files, build the application using the one or more configuration files, and directly load the application over a selected application distribution platform (such as iStore™) or an application server. In an exemplary implementation, the application builder can publish and manage the application directly from the personal computing device of the user, wherein the personal device can be a mobile phone, a smart phone, a laptop, a personal computer, a tablet PC, or any other like computing device.

In another aspect, the proposed application builder can allow a user to select one or more platforms for a particular sector, for example for the insurance sector for which the customized application needs to be built. The application builder can also allow the user to select basic application layout that may be pre-designed to achieve particular business and marketing objectives. The application builder can also allow a user to generate applications for different platform and automatically publish the customized application on the application distribution platform to communicate, promote, sell, engage and retain customer for the services offered by the user. In an implementation, using the proposed system (also referred to as the application builder), user can also easily add/remove one or more pages or features in the customized application and publish the updated customized application.

In another embodiment of the present disclosure, the proposed system allows building/development of customized mobile application for insurance sector, and can provide highly customizable, ready to use designs that give flexibility to build the desired application with easy to edit designs, features and elements. It can allow a user to have full control over the look and feel with countless fonts, color palettes, icons, etc. More particularly, the present disclosure provides a system having a core engine to dynamically build and deploy customized application(s) for insurance agents. Application builder/System can take one or more details such as market, location, company's name, logo and colors to build a unique and customized mobile application for use by agents, wherein multiple features including but not limited to multi-lingual, geospatial coding features, mobile insight, etc. can be picked and selected on the click of a button by the user in the form of text, images, color selections and drag drop facility. Therefore, this unique and decoupling feature of the proposed system application can enable a user to design a professional application for customized usage by following few steps without involving an IT programmer to create the desired application. Mobile application builder of the proposed invention can provide a means to develop a customized application at a fraction of cost for development of an application in traditional manner by an IT professional. As hiring a skilled mobile developer capable of programming cross-platform personalized application can be over budgeted, with the proposed mobile application builder, the application can always be updated with the latest web, iOS™, Android™ and Symbian™ requirements.

In an aspect, mobile application builder of the present disclosure can enable a client/user to connect with the digital world through a customized mobile application by plugging in existing content virtually from anywhere and synchronizing the developed application with website, portal, blog RSS, social media accounts, E-commerce, and also have more content updates in the developed application. It is also possible for the client to boot start application marketing from a single panel.

In an aspect, the present disclosure relates to a system for creating a customized mobile application comprising a non-transitory storage device having embodied therein one or more routines operable to facilitate creation of the mobile application; and one or more processors coupled to the non-transitory storage device and operable to execute the one or more routines, wherein the one or more routines are executed in conjunction with a second set of routines stored on an application development and test server, and wherein the one or more routines include: a customization input receive module, which when executed by the one or more processors, receives one or more customization inputs from a user; a user information retrieval module, which when executed by the one or more processors, automatically and dynamically retrieves at least one user information attribute from one or more servers that the system is operatively coupled with; an input verification module, which when executed by the one or more processors, verifies the received one or more customization inputs and the dynamically retrieved at least one user information attribute; a configuration file creation module, which when executed by the one or more processors, creates at least one configuration file based on the verified one or more customization inputs and the dynamically retrieved at least one user information attribute; a web service file creation module, which when executed by the one or more processors, creates at least one web service file for configuration or hosting on a web/application server; and an application publication module, which when executed by the one or more processors, builds the at least one configuration file and the at least one web service file to generate and publish an executable file of the mobile application.

In an aspect, the system can be configured on a user device, said user device being selected from any or a combination of a mobile phone, a smart phone, a tablet PC, a PDA, a laptop, a desktop PC, and a display based computing device.

In another aspect, the one or more customization inputs can relate to any or a combination of inputs relating to theme for the application, icon(s) to be used for the application, image(s) to be used for the application, platform on which the application is to be run, business industry for which the application is to be developed, jurisdiction(s) in which the application is intended to be accessible, features to be present in the applications, background and color scheme for the application, positioning/location of graphical interface items, layout of the application, content to be depicted in the application, branding information to be used for the application, and logo(s) to be used for the application.

In an aspect, the input verification module can further be configured to verify if any content or part thereof is invalid or conflicts with content of other applications.

In yet another aspect, the system can further include a commit module, which when executed by the one or more processors, commits the at least one configuration file and the at least one web service file to a versioning and revision control means.

In an aspect, the mobile application is an application for insurance agents, where at least one configuration file of the insurance application can include any or a combination of an identifier of at least one insurance agent, jurisdictions/territories covered by the at least one insurance agent, insurance companies contracts that the at least one insurance agent has, experience and location of the at least one insurance agent, insurance application platform, type of insurances provided by the at least one insurance agent, demographic details of the at least one insurance agent, and insurance application theme related information.

The present disclosure further relates to a method for creating a customized mobile application comprising: receiving, by a computer system, one or more customization inputs from a user; automatically and dynamically retrieving, by the computer system, at least one user information attribute from one or more servers that the system is operatively coupled with; verifying, by the computer system, the received one or more customization inputs and the dynamically retrieved at least one user information attribute; creating, by the computer system, at least one configuration file based on the verified one or more customization inputs and the dynamically retrieved at least one user information attribute; creating, by the computer system, at least one web service file for configuration or hosting on a web/application server; and building, by the computer system, the at least one configuration file and the at least one web service file to generate and publish an executable file of the mobile application.

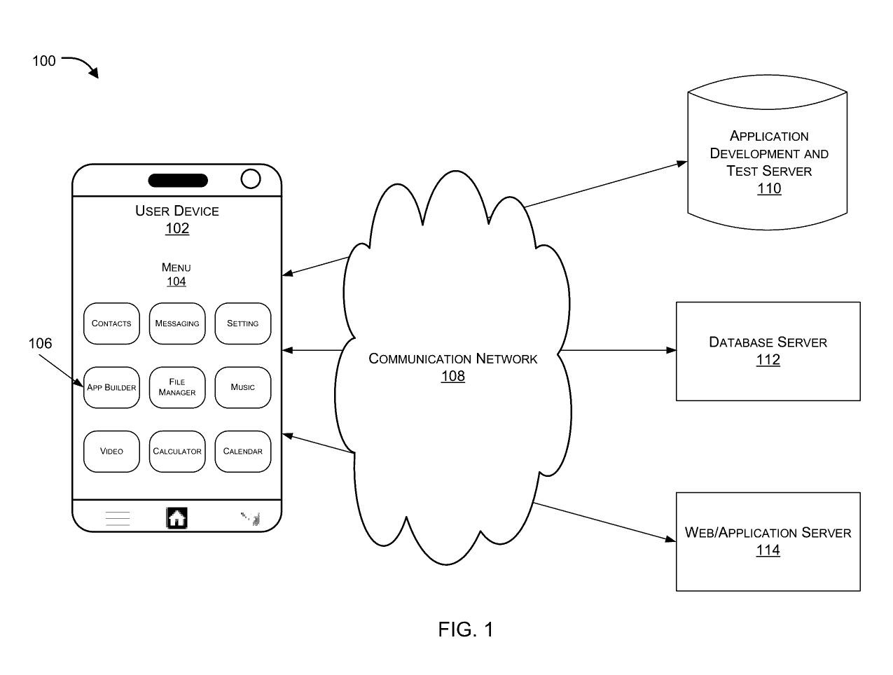

FIG. 1 illustrates an exemplary architecture for mobile application development and publication in accordance with an embodiment of the present disclosure. As shown in FIG. 1, a user, through a user device 102, can browse through mobile menu 104, which can include pre-installed applications on the user device 102, wherein the menu 104 can also include an application builder 106 (also referred to as system 106 hereinafter), which the user can download from an application distribution platform (such as iStore™). The mobile application builder 106 can also be pre-installed on the user device 102 at the time of device purchase and therefore come as part of the applications that are provided by the operating system.

In an aspect, in order to access the application builder 106, user of the device 102 can select the menu 104, and then select the icon corresponding to the application builder 106 present in the menu 104. The application builder 106, upon launch, can be connected to an application development and test server 110, a database server 112, and a web/application server 114 through a communication network 108. In an exemplary implementation, the application builder 106 can communicate with application development and test server 110 for customization, building and testing of the application before publishing. Also, the application builder 106 can fetch details from database server 112 for filling up details, if required, of the user, whereas the web/application server 114 can be used to finally publish the application on an application/app store.

In an exemplary implementation, application builder 106 of the present disclosure can retrieve one or more themes, basic features, pre-existing code base, frames etc. based on user selected platform, industry sector, and application jurisdiction (if required), from the application development and testing server 110. The application builder 106 can further receive customization in put from the user, and accordingly build and publish the customized application on an appropriate application distribution platform and/or web/application server 114. The application builder 106 can perform all network configurations such as hosting IP address setting, connection with database server 112, DNS setting, application distribution platform based setting so as to enable the customized application to be used by the intended customer instantly.

In an embodiment, user device 102 can include, but is not limited to, mobile phone, smart phone, tablet PC, PDA, and the like, as would be known to people having ordinary skill in the art.

In an another embodiment, user can provide input to user device 102 by using any mechanism, including but not limited to, touch, gesture, voice, hover and the like. In another embodiment, user can select themes from a cloud service if user's choice of background screen is not available within the application builder 106.

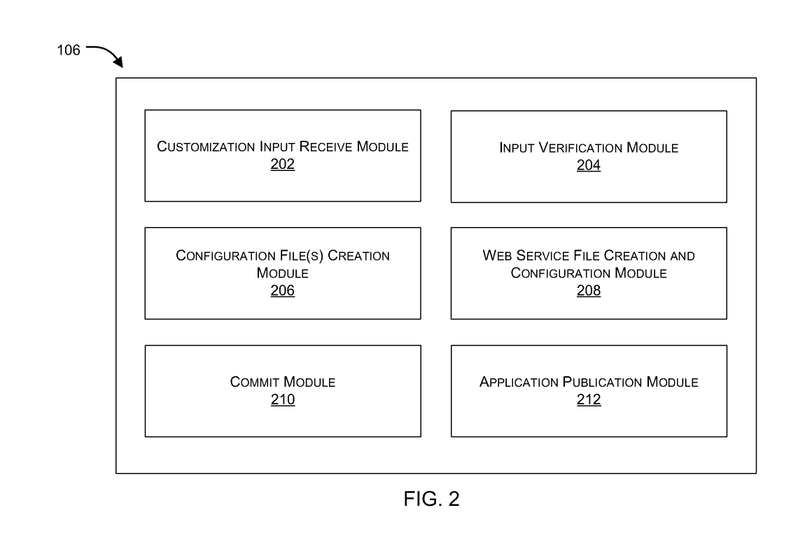

FIG. 2 illustrates exemplary functional modules of an application builder based system in accordance with an embodiment of the present disclosure. In an aspect, the proposed system/application builder 200 can include a customization input receive module 202 configured to receive one or more mandatory and/or optional customization inputs from a user for developing/building a customized application, an input verification module 204 configured to verify the mandatory customization input, a configuration files(s) creation module 206 configured to automatically create required configuration files or edit existing configuration files, a web service file creation and configuration module 208 configured to create web service files and configure web resources, a commit module 210 configured to submit all changed to, for instance, Apache Subversion (SVN) or a like platform, and an application publication module 212 configured to build and publish/upload the customized application on an application distribution platform and/or over an application server.

According to one embodiment, customization input receive module 202 can be configured to receive basic configuration input such as platform selection, industry sector selection, and jurisdiction selection from a user, and based on these basic configuration inputs, appropriate features for customization can be loaded. The input receive module 202 can further provide option for the user to select an appropriate layout from a plurality of existing layouts, an option to enter/select other customization inputs such as look and feel of the application, basic theme, graphical user interface (GUI) level parameters/inputs, buttons, data, images, background, theme, photos, maps and locations, application branding information, text color, icon color, and any other desired imagee.g.main page graphics and other images. In an exemplary implementation, customization input receive module 202 can allow user to upload images such as logo, main page graphic, icons, etc. from the user device or provide a link to upload these images from a remote computing device. In an example implementation, the received images can be copied from a location that is specified by the user into specific folders, for example in mdpi, hdpi and xhdpi folders.

In an aspect, upon receiving customization input from user, input verification module 204 can be configured to check/verify validity of the input data being entered. Module 204 can verify if mandatory fields are entered or not such that if any of the mandatory fields is not entered by the user, the application builder 106 can show an appropriate error. Further, input verification module 204 can be configured to verify if some marked inputs, as received from the user, conflict with existing/already developed mobile applications. For example, logos, images, copyrighted content, among other like material/content can be automatically compared and/or verified against other published mobile application across one or more stores so as to indicate/alarm the user in case there is a potential infringement or threat.

In another aspect, once the received customization inputs are verified by the input verification module 204, configuration file(s) creation module 206 can be configured to create one or more configuration files for use at compilation or building stage of the application. In an exemplary implementation, configuration file creation module 206 can be configured to create configuration file(s) that contain theme information and customization input information (received from module 202), say in .xml format. Configuration file creation module 206 can automatically make changes in the configuration files wherever required, and can compile codes accordingly for building the application. In an exemplary implementation, configuration file creation module 206 can be configured to manipulate the .svg files (Scalable Vector Graphic files), and change color(s) inside files based on color(s) provided as customization input.

It would be appreciated that file type or any other attribute/parameter thereof is not limiting the scope of the present disclosure in any manner, and any file type is well within the scope. It would also be appreciated that although the proposed disclosure explains few embodiments with respect to applications being built for insurance agents, the same is only one exemplary implementation, and the proposed architecture can be used in any other industry/business vertical, all of which are well within the scope of the present disclosure.

In an aspect, web service file creation and configuration module 208 can be configured to create one or more web files (also referred to web service files), which can be uploaded onto a web server that is going to host the application. In an exemplary implementation, module 208 can configure one or more required web resources for running the application, and can copy the web service file(s) from user directory to assets directory of specific agent application server. In an exemplary implementation, commit module 210 can be configured to commit all the above changes on SVN or any other like software versioning and revision control system. Application publication module 212 can be configured to build the application from an updated SVN, and published the application on an application distribution platform and application server, wherein, in an exemplary implementation, application publication module 212 can use an apache engine for processing the building process of the application on the device, and for publishing the application over the server. In an aspect, the customized application published on the application distribution platform such as App store, Google play etc. or on any other application server can be downloaded and used by a customer of the user.

In an aspect, application builder of the present disclosure can be customized as an application builder for insurance agents that can allow an insurance agent/agency to dynamically build and deploy a customized application on Google's play, Apple's iStore, among other like platforms. In implementation, insurance agent/agency can provide their intended market details, locations, company's logo, background colors, product names, service name, agents name etc. as customization input, based on which the application builder 106 can build a unique mobile application for the insurance agent/agency using creation of configuration files and web service files that can be executed to implement the application. As one may appreciate, the total application building and deployment process may be completed in less than 15 minutes, and therefore provides greater freedom and speed to market for insurance agents/agencies. An insurance agency can create a customized application for any particular product or product segment. User/insurance agent/insurance agency representative can pick and choose by a click of button from multiple features such as multi-lingual, Geospatial coding features, Mobile Insight, among others to provide customization input for building and publishing a customized application. The application builder can be designed in such a way that makes it completely agnostic (ignorant) about the product being built. With this decoupling, any future mobile project can be made compatible with the builder to allow customization.

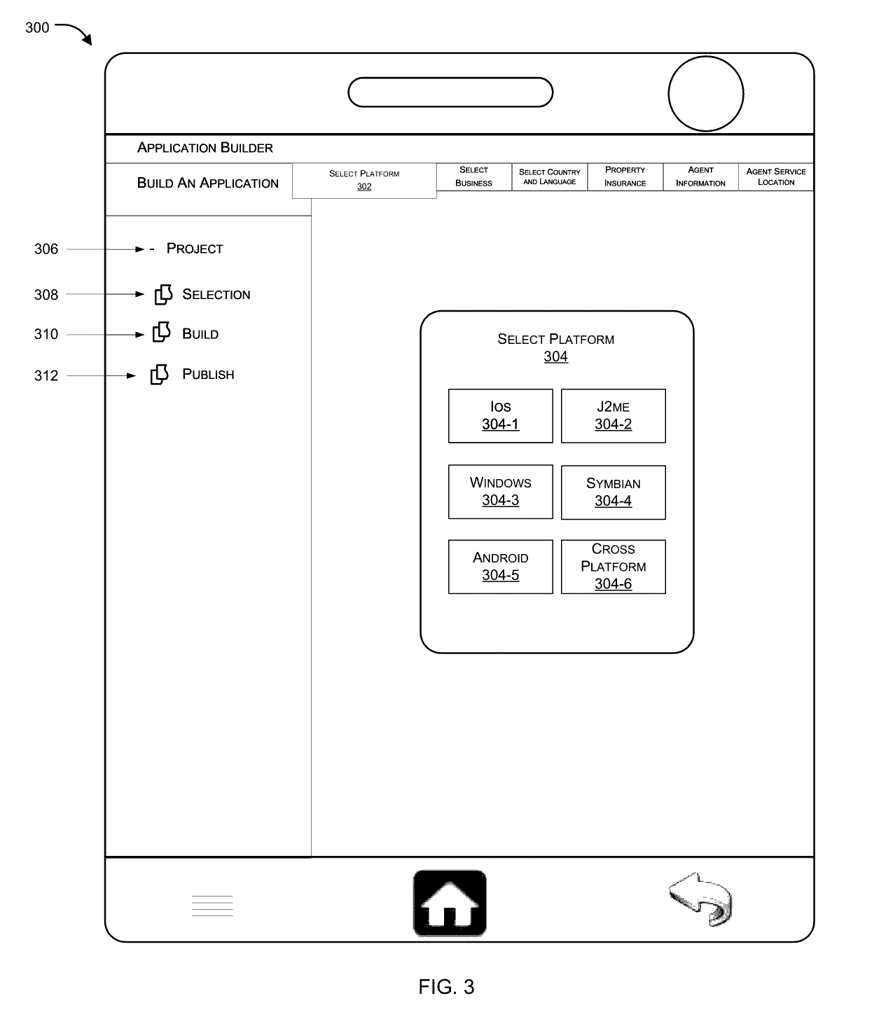

FIG. 3 illustrates an exemplary diagram depicting platform selection for application building in accordance with an embodiment of the present disclosure. In an aspect, the application builder 106 can include different tabs designed to receive different inputs from a user. Such tabs may include, for example, a select platform tab 302, a select business tab, a select country and language tab, a property insurance tab, an agent information tab, an agent service location tab, an industry sector selection tab, among other like tabs to configure various features of the application being developed. Different tabs on the application builder 106 can be used by the user for providing/selecting different customization input(s) based on which the user wants to build the customized application.

In an aspect, application builder or the proposed system 106 can also have one or more folders that can store previous applications developed by the user, for instance. For example, on the left hand side, the application builder 106 can include a project folder 306 that can include previous and instantly developed projects/applications. The application builder can further include status tabs for indicating the progress of the present project. For example, a selection 308 tab can be configured to allow user to browse through different selection options to provide customization input, build tab 310 can be configured for building a customized application, and a publish tab 312 configured to publish the built customized application on an application distribution platform or on an application server. As one may appreciate, a project can be a new customized application that the user wants to create.

Upon selection of a project and selection tab 308, application builder 106 can initially present platform selection tab 302 for selecting a suitable application platform for which the user intends to develop the customized application. The select platform tab 302 can include multiple platforms such as iOS™ 304-1, J2ME™ 304-2, Windows™ 304-3, Symbian™ 304-4, Android™ 304-5, and cross platform 304-6 for which the user intends to build and publish the customized application. User can select any platform, for example, iOs 304-1 platform from the given set of platforms on which the application is intended to be built and launched later on the respective application distribution platform. Cross platform 304-6 selection can enable the application to work on multiple platform once built.

Although not being limited to, in one exemplary implementation, icons displaying different platforms, including but not limited to, iOS™ 304-1, J2ME™ 304-2, and the like, can be arranged in any order.

In an embodiment, any or a combination of background theme, text size/color, color of the user interface displayed on the computing device, size of icons, presentation of buttons/icons/dropdown items, among like can be customized.

Although not being limited to, in one exemplary implementation, one or more platforms, including but not limited to, Symbian, Open webOS, and the like, can be added on the user interface to develop customized application, all of which possible implementations/embodiments are well within the scope of the present disclosure.

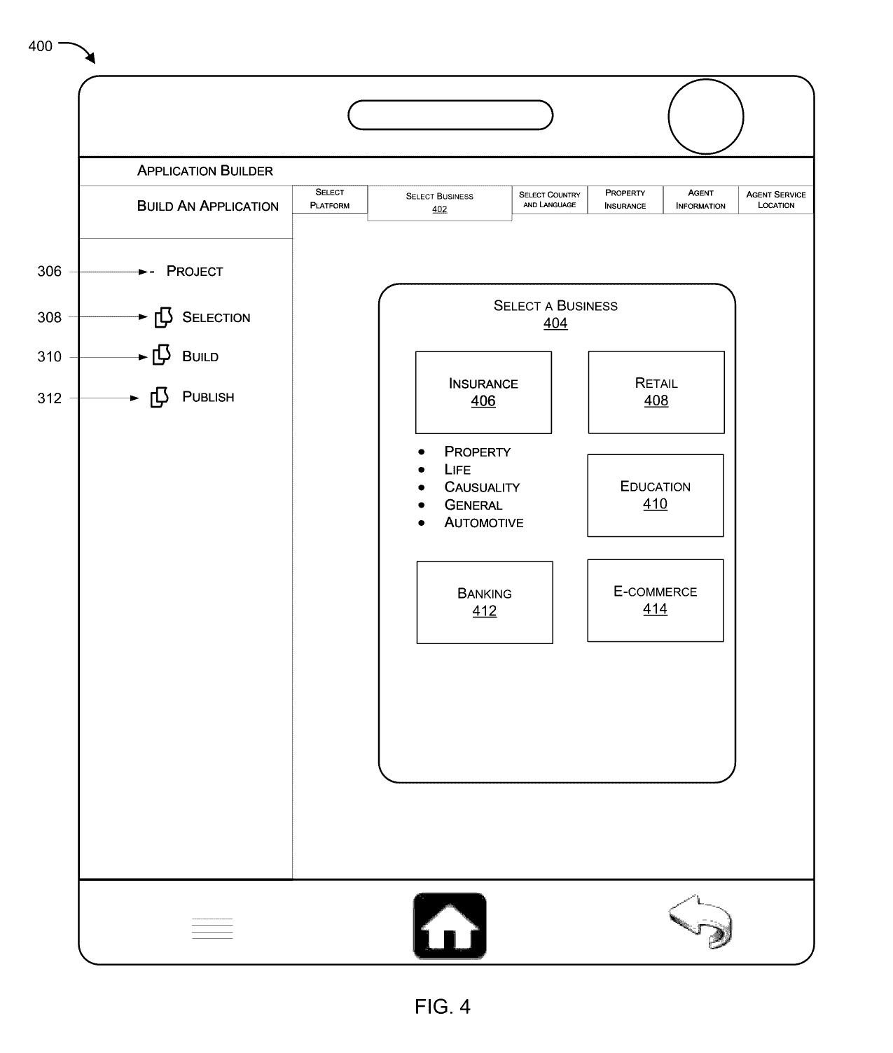

FIG. 4 illustrates an exemplary diagram depicting business domain selection in accordance with an embodiment of the present disclosure. As shown in FIG. 4, upon selection of the “Select Business” tab 402, application builder 106 can allow a user to specify and choose the business for which the application needs to be build. The Select Business tab 402 can be configured to present different business sectors based on pre-configuration of the application building/proposed system. For instance, application builder 106 of the present disclosure can be pre-configured to build customized applications related to insurance, based on which the application builder 106 can provide the user, under the select business tab 402, options to select different types of insurance 406 such as property, life, casualty, general and automobile insurance. The select business tab 402 can also present other sectors such as retail 408, education 410, banking 412, and ecommerce 414 for which the user can create the customized application. In implementation, when the insurance icon 406 is selected, a drop down screen can appear for selecting sub-options that are specific to different insurance sectors. In the present exemplary scenario, user can opt for Property as the sub-insurance sector by selecting/clicking on the Property link from the drop down screen under the select business tab 402.

In an exemplary implementation, based on selected industry/sub-industry by a user, application builder 106 of the present disclosure can automatically retrieve complete structure and information dynamically from one or more servers that are connected to the user device via communication network for further progress on application development. In an exemplary implementation, source codes and other modules related to the selected category can be downloaded/loaded by the application builder based on user selection of the industry sector.

In an embodiment, business sectors and their respective sub-options/categories/features can be displayed, including but not limited to, in a drop down fashion, 3-D display, or any other presentation format as may be known to a person having ordinary skill in the art.

In another embodiment, any or a combination of icons of business sectors or their respective sub-options/categories/features can be edited in terms of their size, content, shape, presentation, font, among other like formatting parameters.

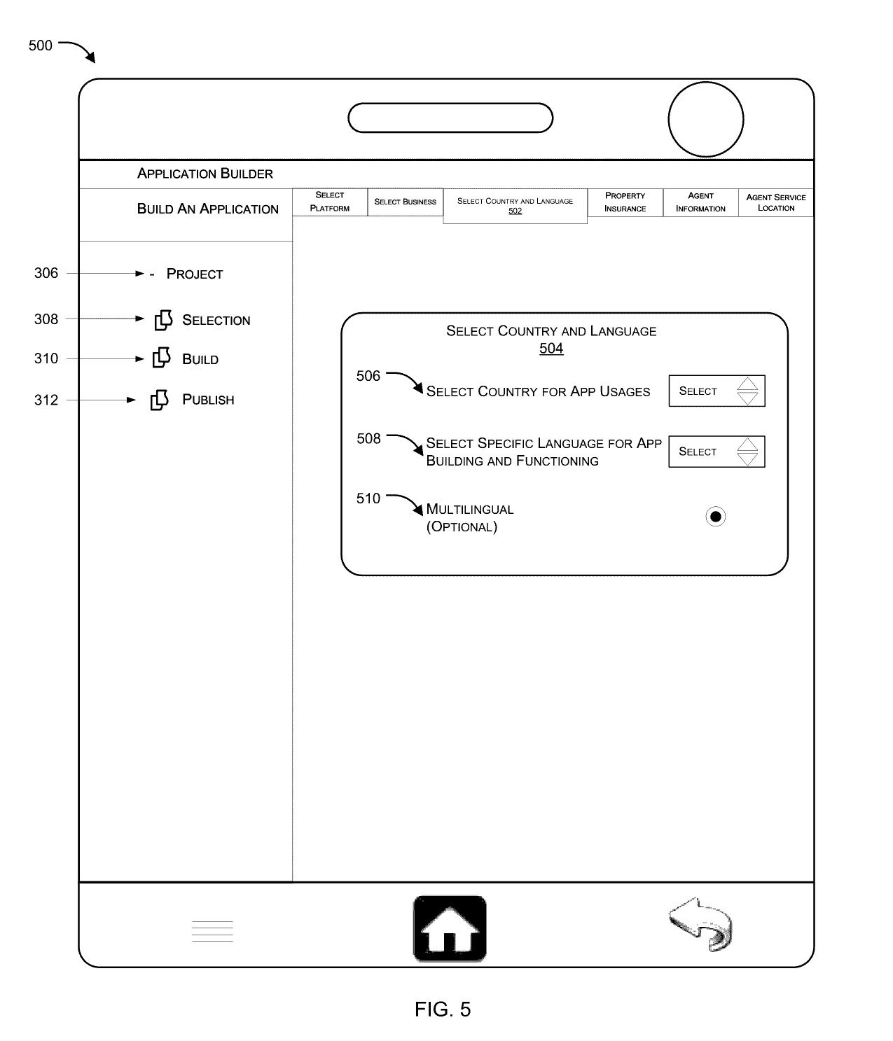

FIG. 5 illustrates an exemplary diagram depicting country and language selection for application development and functioning in accordance with an embodiment of the present disclosure. In an aspect, a user can select country and language tab 502 to open an interface showing “Select country and language 504”, which allows user to select a country 506 for which the application is being built or where the application is indented to be used. The user may also be required to select natural language 508 for which the application is to be developed, wherein, the selected natural language can be any language from all over the world, and can be selected within the box by scrolling the options. The select language tab 508 can also provide other features such as multilingual selection 510 that can be enabled by clicking on the button selection. The application can be functional and/or operable through different languages on dynamic selection (as this feature can be enabled in the application design) of any particular language known to the user, but the user can only use the application in those different languages coming under the country being selected 506.

Although not being limited to, in one exemplary implementation, selection of a country can automatically display cities of the selected country for which the application is intended to use.

In an embodiment, user can add/modify country/city name according to his/her choice.

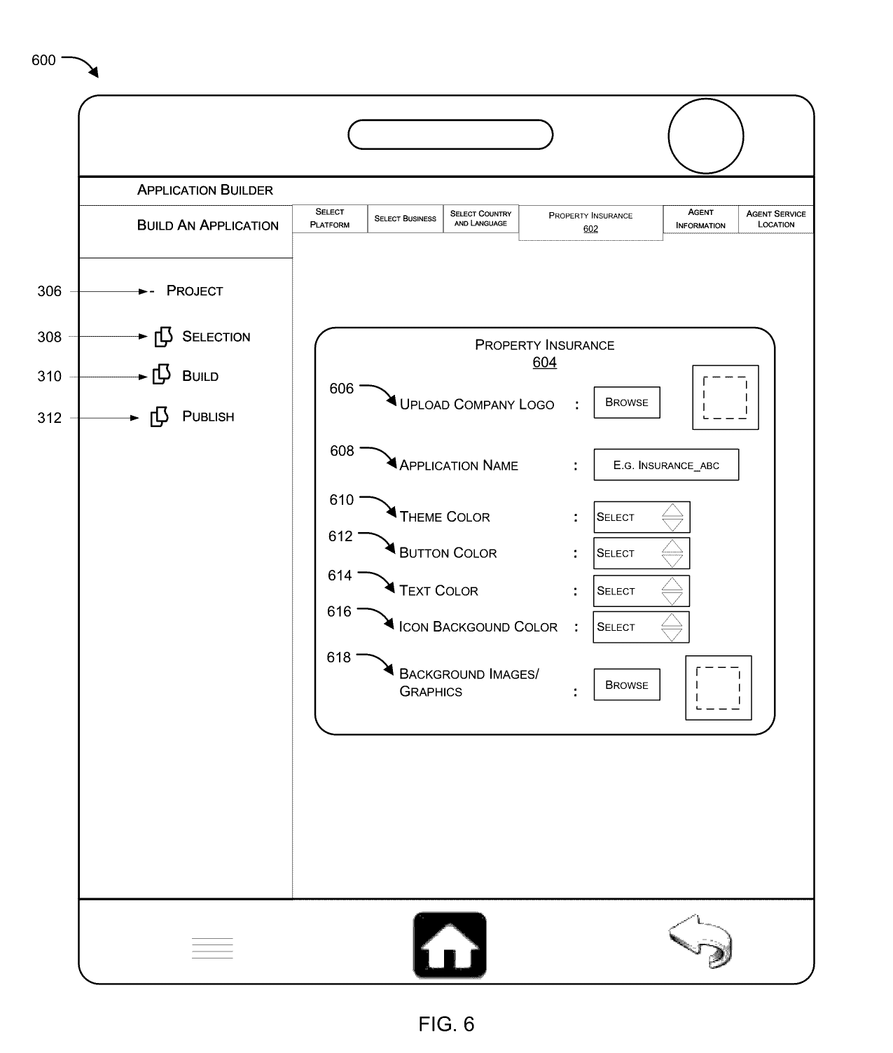

FIG. 6 illustrates an exemplary diagram depicting property insurance details entry screen in accordance with an embodiment of the present disclosure. In an aspect, a user can go to the property insurance tab 602, under which, screen “Property Insurance 604” can be presented. The screen 604 can accordingly enable user to upload, for instance, company's logo 606 and/or application name 608 of the customized application. In an exemplary implementation, as the user enters the application name or proposed logo, the application builder 106 can automatically check availability of the name from a defined local/remote name database and/or from the application distribution server so as to verify that the same application name and/or logo is not being used by any other user. User can also select theme color 610 to customize color of the application, button color 612 to define color(s) of different icons/buttons/links/items/objects, text color 614, icon background color 616 that may be displayed as a background color of the icons being shown in the application, and background image or graphics 618 from the user device/server. In an instance, user can enter proposed name of the application as Insurance_ABC in the application name 608 field, which the application builder can accordingly verify for availability for use.

In an embodiment, any number of additional fields such as for entering additional property details, previewing uploaded images, adding premium details adding insurance plan details, among others can be configured in the property insurance screen 604 or on any other screen, all of which possible options/embodiments are well within the scope of the present disclosure.

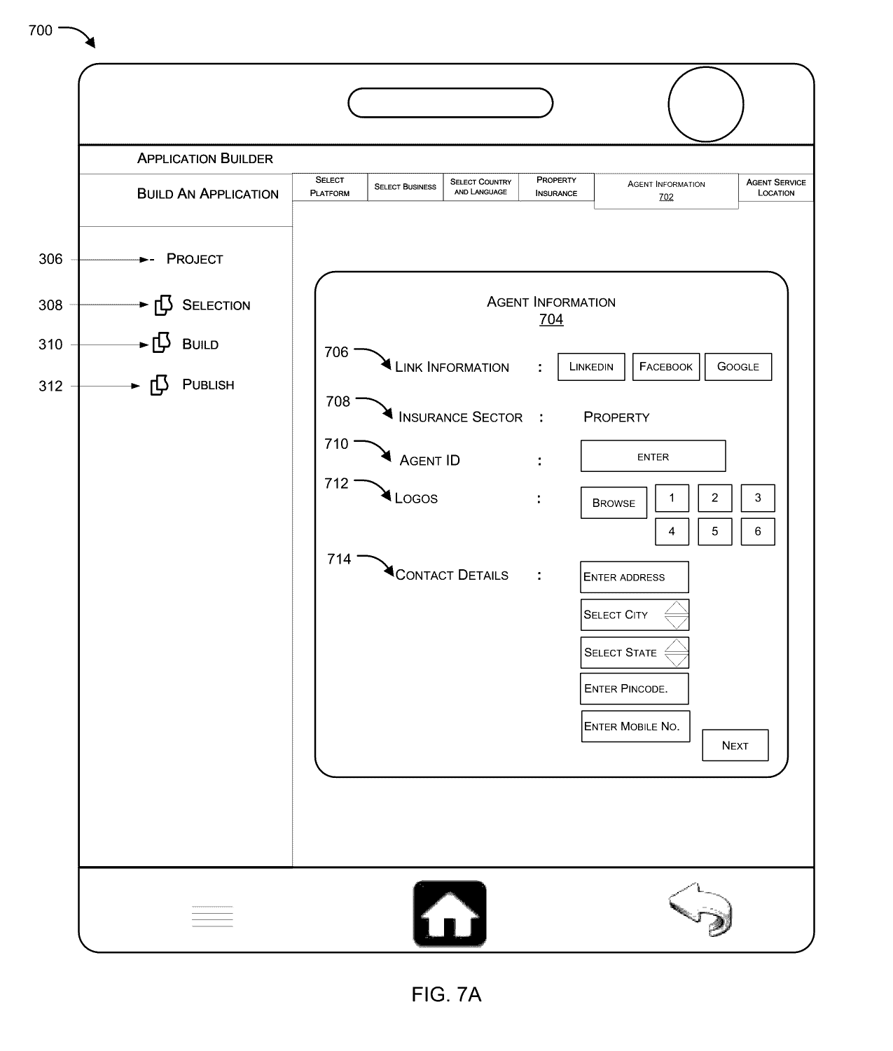

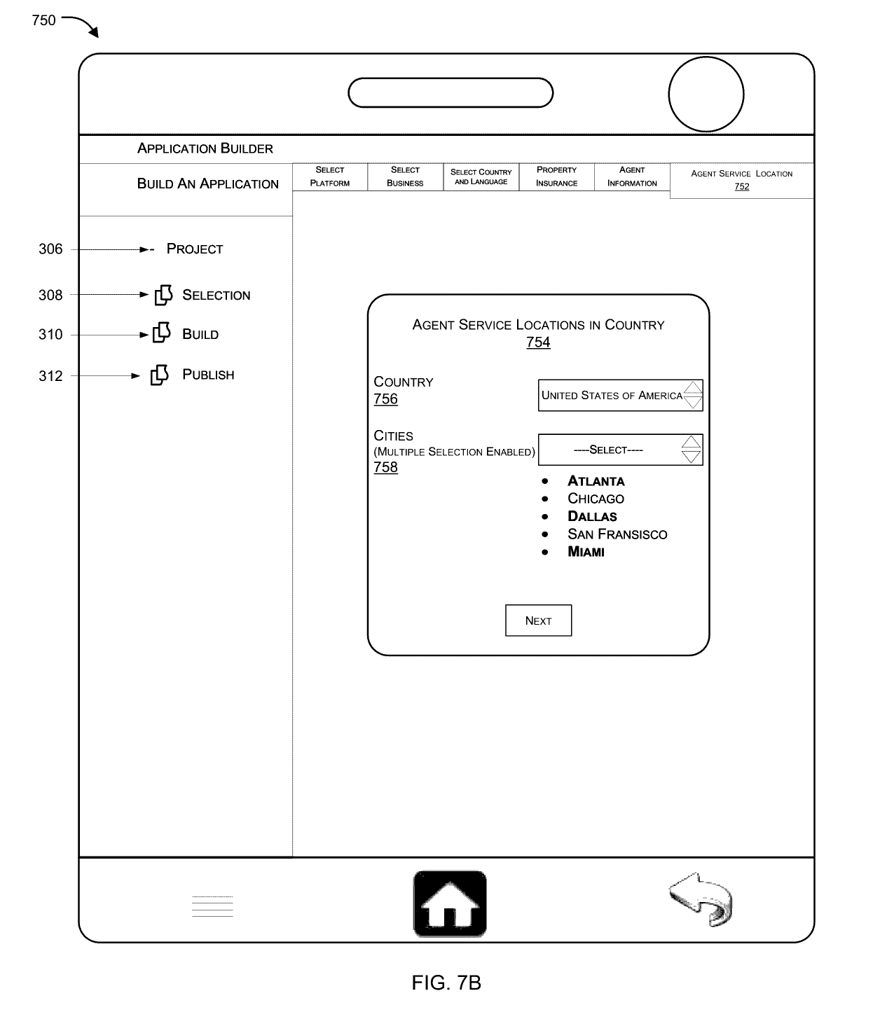

FIG. 7(A) illustrates an exemplary diagram showing agent's personal details screen in accordance with an embodiment of the present disclosure. Under the tab “Agent Information 704”, a user can enter his/her details if he/she is an insurance agent. The agent information screen 704 can include details such as social media link of the agent 706, insurance sector 708 for which the user works as an agent i.e. chosen as Property at earlier stage (under the tab Select Business as sub category of Insurance Business). In addition, agent ID 710, which can be a unique identifier assigned to the agent by an authorized institution, can be entered by the user/agent. Furthermore, one or more images/logos 712 that may need to be placed in the intended application can be browsed and chosen from within the device or from an available database server or web server. User can also be enabled to select multiple logos for different insurance companies that the user/agent may have license of Contact details 714 can include details such as address, city, state, pin code and mobile number of the user or agent that can be shown in the contact details on the application once it gets published on the store and can be accessible to the clients of the user.

In an embodiment, information such as contact details can be stored by the proposed system for records purposes on a database server, and can, for instance, be used when the same user creates another application or edit the existing ones.

In an embodiment, agent's social media link information can be dynamically retrieved from one or more sources, including but not limited to, online agent management services, carriers, social networking sites such as Linkedin, Facebook, and the like, as may be known to a person having ordinary skill in the art.

In an embodiment, one or more entries of the mobile application builder can be enabled with auto-complete feature.

FIG. 7(B) illustrates an exemplary diagram showing agent service locations screen in accordance with an embodiment of the present disclosure. The agent service location tab 752 can include a screen 754 for entering location details of an agent. The agent or user can specify and select country 756 for residence as well as for business operations. Further, the user or agent can define multiple cities 758 that are within the reach for doing business activities under the specified country selected by the user or agent. For example, as shown in FIG. 7(B), the country selected is United States of America, and multiple cities selected are Atlanta, Dallas, and Miami. One can scroll up or down onto the list displayed to browse for other cities present in the list.

In an embodiment, an option to enter a new field, including but not limited to, adding a new country and/or a city can be utilized to enable aspects of the invention.

Although not being limited to, in one exemplary implementation, a time limit for validity of the customized application can be added during which the application is intended to be used/valid in a particular country.

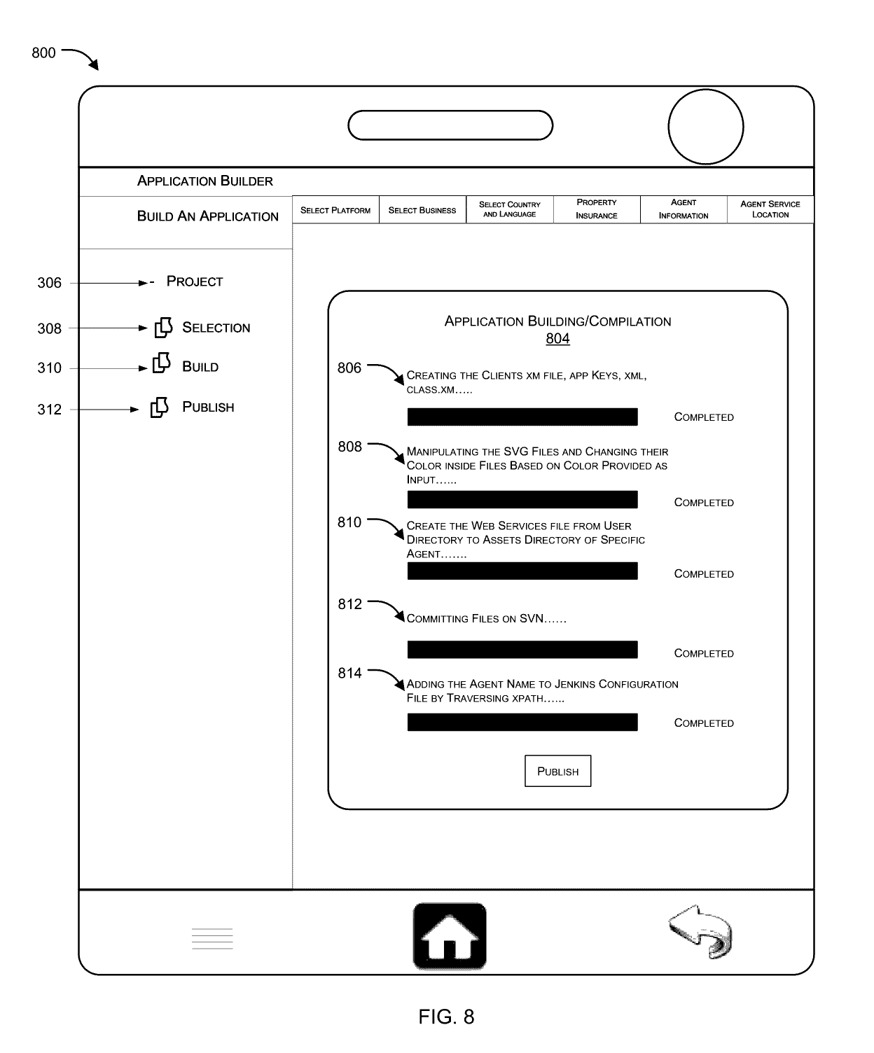

FIG. 8 illustrates an exemplary diagram showing progress of compilation/building steps of customized application in accordance with an embodiment of the present disclosure. Upon completion of previous steps of selection, system 106 of the present disclosure can automatically proceed towards building/compilation process as shown at screen 804 that can be presented when the user selects the Build 802 option.

In an exemplary implementation, building/compilation shows the progress of various steps including step 806 for creating client XML file(s) and application keys as configuration file(s) that contain theme information and agent information step. The process can further include step 808 for manipulating scaled vector graphics (SVG) files (such as icons that are programmatically colored and converted to .PNG images in different resolutions) and changing their color based on color provided as input by the user. The process further includes step 810 to create web service file(s) (configuration file(s) specifying how the application should communicate with the server), and copy the web service file(s) from user directory to assets directory of specific flavour agent or insurance agent.

The process as shown at the building/compilation step 804 can further include committing web service file(s) and configuration file(s) on SVN (Apache Subversion) or any other appropriate software versioning and revision control system. Finally, the process includes, at step 814, adding the agent name to Jenkins configuration file by traversing XPATH so as to enable development server to pick up code from SVN and generate an executable file.

In an aspect, all these compilations and/or files can be configured in communication with the various severs connected to the device for mobile application builder 106. Once all these compilations are completed and the application is built, the user can click on the publish button to publish the application and proceed to the next stage.

In an exemplary embodiment, files that completed 100% compilation can be deleted from the user interface. In another exemplary embodiment, user can select particular configuration files that can only show progress.

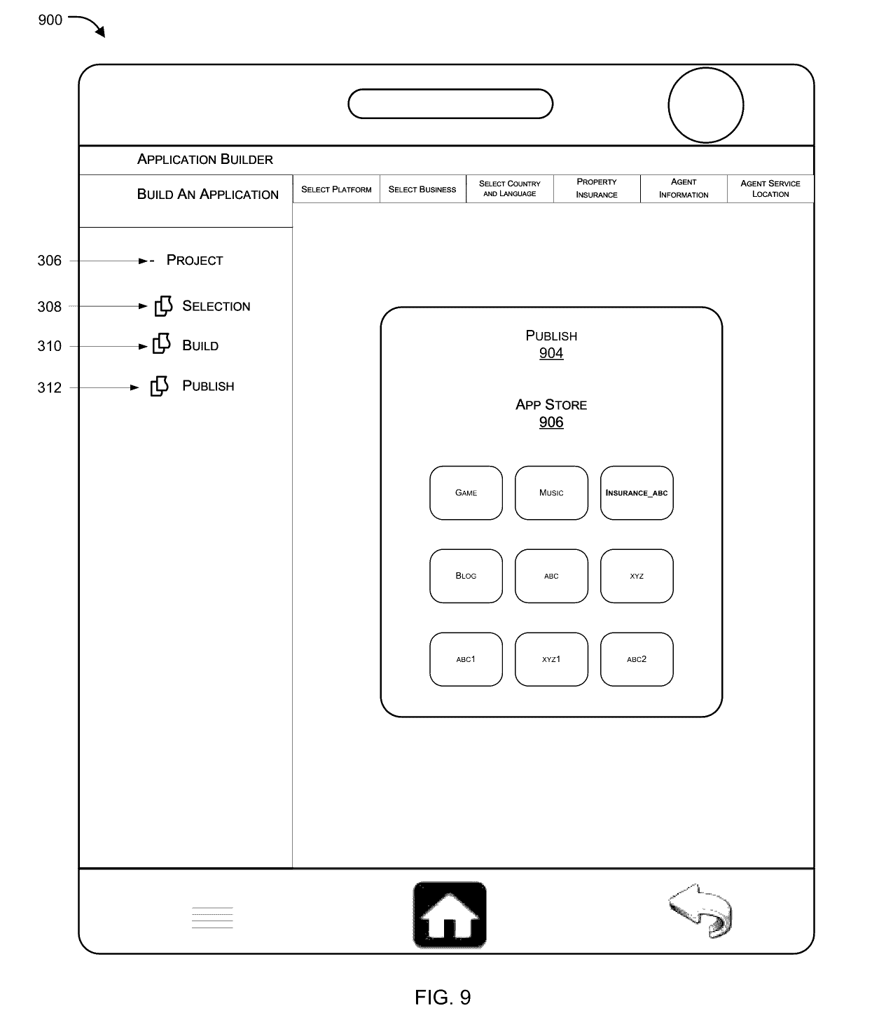

FIG. 9 illustrates an exemplary diagram showing launched insurance application on an Application store in accordance with an embodiment of the present disclosure. System 106 of the present disclosure can launch Insurance_ABC application on an appropriate/desired application store of the previously selected platform, for instance, iOS after successful compilation of the application. User or any other client can access the created application from the application store by using his/her mobile device. Also, if required, clients of the user belonging to his/her insurance sector can access the same application for entering their queries and/or for other activities as allowed/configured by the user.

In an embodiment, customized application building can be a paid service, wherein the amount of payment can be dependent on number and type of features that a user uses or adds into his/her application. In an embodiment, paid service can also be time-based, including but not limited to, monthly charges, annual license fees, and the like.

Although not being limited to, in one exemplary implementation, payment can be executed in any fashion, including but not limited to, credit card payment, mobile banking, and the like, to enable the aspects of the present disclosure.

Although not being limited to, in one exemplary implementation, when a client insures a vehicle, vehicle details such as vehicle number can be manually entered or can be scanned automatically to enable aspects of the invention. In an embodiment, vehicle details can also be retrieved by using a cloud service and accordingly, other details, including but not limited to, vehicle owner name, vehicle owner's date of birth, premium amount, and the like can be determined automatically. In an embodiment, payment for insurance can be performed by any mechanism, including but not limited to, sending a text message as email that can include an insurance code and a link, which when clicked, enables a user to make payment.

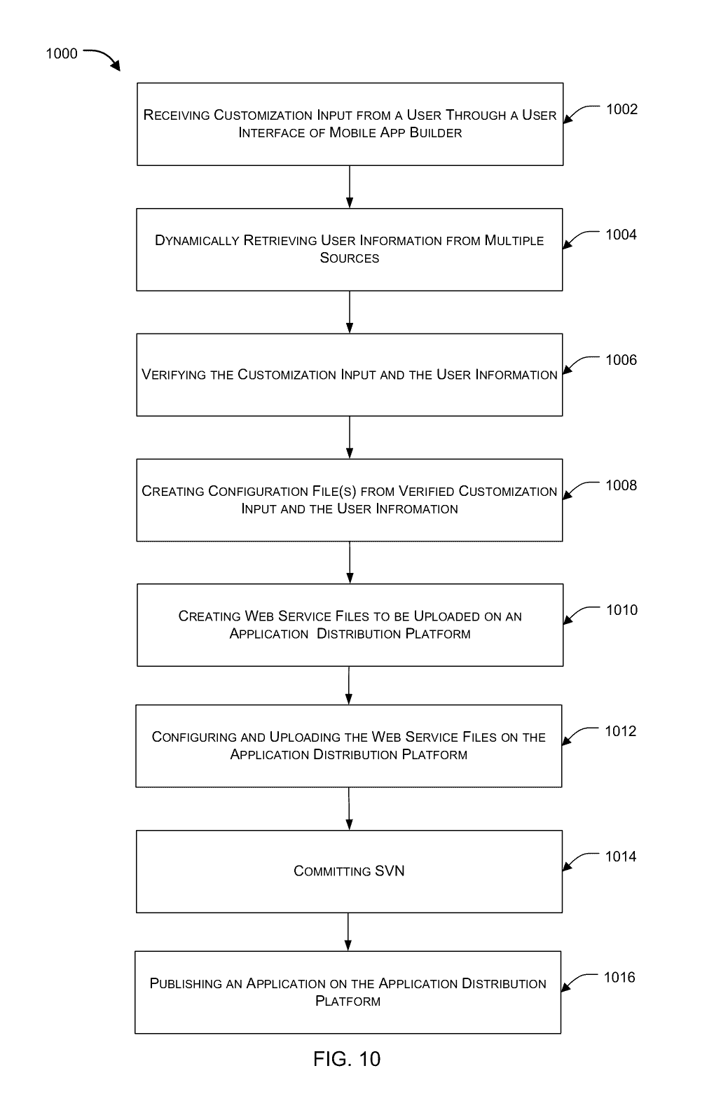

FIG. 10 illustrates an exemplary flow diagram 100 depicting steps involved in building an application in accordance with an embodiment of the present disclosure. In an aspect, the proposed method can include the steps of, at step 1002, receiving customization input from a user through interface of a mobile application builder, and at step 1004, dynamically retrieving/populating additional user information from one or more sources. Method 1000 can further include, at step 1006, verifying the customization input and/or the dynamically retrieved user information. At step 1008, one or more configuration files are generated/created based on verified customization input and/or the dynamically retrieved user information, and at step 1010, the method can include creating one or more web service files to be uploaded on an application distribution platform.

In an aspect, the method can further include, at step 1012, configuring and uploading the web service files on the application distribution platform, and at step 1014, committing SVN to, at step 1016, build and publish the application on the application distribution platform.

While the foregoing describes various embodiments of the invention, other and further embodiments of the invention may be devised without departing from the basic scope thereof. The scope of the invention is determined by the claims that follow. The invention is not limited to the described embodiments, versions or examples, which are included to enable a person having ordinary skill in the art to make and use the invention when combined with information and knowledge available to the person having ordinary skill in the art.

We claim:

1. A system for creating a customized mobile application comprising:
a non-transitory storage device having embodied therein one or more routines operable to facilitate creation of the mobile application; and
one or more processors coupled to the non-transitory storage device and operable to execute the one or more routines, wherein the one or more routines are executed in conjunction with a second set of routines stored on an application development and test server, and wherein the one or more routines include:
a customization input receive module, which when executed by the one or more processors, receives one or more customization inputs from a user;
a user information retrieval module, which when executed by the one or more processors, automatically and dynamically retrieves at least one user information attribute from one or more servers that the system is operatively coupled with;
an input verification module, which when executed by the one or more processors, verifies the received one or more customization inputs and the dynamically retrieved at least one user information attribute;
a configuration file creation module, which when executed by the one or more processors, creates at least one configuration file based on the verified one or more customization inputs and the dynamically retrieved at least one user information attribute;
a web service file creation module, which when executed by the one or more processors, creates at least one web service file for configuration or hosting on a web/application server; and
an application publication module, which when executed by the one or more processors, builds the at least one configuration file and the at least one web service file to generate and publish an executable file of the mobile application.

2. The system of claim 1, wherein the system is configured on a user device, said user device being selected from any or a combination of a mobile phone, a smart phone, a tablet PC, a PDA, a laptop, a desktop PC, and a display based computing device.

3. The system of claim 1, wherein the one or more customization inputs relate to any or a combination of inputs relating to theme for the application, icon(s) to be used for the application, image(s) to be used for the application, platform on which the application is to be run, business industry for which the application is to be developed, jurisdiction(s) in which the application is intended to be accessible, features to be present in the applications, background and color scheme for the application, positioning/location of graphical interface items, layout of the application, content to be depicted in the application, branding information to be used for the application, and logo(s) to be used for the application.

4. The system of claim 1, wherein the input verification module is further configured to verify if any content or part thereof is invalid or conflicts with content of other applications.

5. The system of claim 1, wherein the system further comprises a commit module, which when executed by the one or more processors, commits the at least one configuration file and the at least one web service file to a versioning and revision control means.

6. The system of claim 1, wherein the mobile application is an application for insurance agents, and wherein the at least one configuration file of the insurance application comprises any or a combination of an identifier of at least one insurance agent, jurisdictions covered by the at least one insurance agent, insurance companies contracts that the at least one insurance agent has, experience and location of the at least one insurance agent, insurance application platform, type of insurances provided by the at least one insurance agent, demographic details of the at least one insurance agent, and insurance application theme related information.

7. A method for creating a customized mobile application comprising:
receiving, by a computer system, one or more customization inputs from a user;
automatically and dynamically retrieving, by the computer system, at least one user information attribute from one or more servers that the system is operatively coupled with;
verifying, by the computer system, the received one or more customization inputs and the dynamically retrieved at least one user information attribute;
creating, by the computer system, at least one configuration file based on the verified one or more customization inputs and the dynamically retrieved at least one user information attribute;
creating, by the computer system, at least one web service file for configuration or hosting on a web/application server; and
building, by the computer system, the at least one configuration file and the at least one web service file to generate and publish an executable file of the mobile application.

8. The method of claim 7, wherein the system is configured on a user device, said user device being selected from any or a combination of a mobile phone, a smart phone, a tablet PC, a PDA, a laptop, a desktop PC, and a display based computing device.

9. The method of claim 7, wherein the one or more customization inputs relate to any or a combination of inputs relating to theme for the application, icon(s) to be used for the application, image(s) to be used for the application, platform on which the application is to be run, business industry for which the application is to be developed, jurisdiction(s) in which the application is intended to be accessible, features to be present in the applications, background and color scheme for the application, positioning/location of graphical interface items, layout of the application, content to be depicted in the application, branding information to be used for the application, and logo(s) to be used for the application.

10. The method of claim 7, wherein the step of verifying comprises verifying if any content or part thereof is invalid or conflicts with content of other applications.

11. The method of claim 7, wherein the method further comprises the step of committing the at least one configuration file and the at least one web service file to a versioning and revision control means.

12. The method of claim 7, wherein the mobile application is an application for insurance agents, and wherein the at least one configuration file of the insurance application comprises any or a combination of an identifier of at least one insurance agent, jurisdictions covered by the at least one insurance agent, insurance companies contracts that the at least one insurance agent has, experience and location of the at least one insurance agent, insurance application platform, type of insurances provided by the at least one insurance agent, demographic details of the at least one insurance agent, and insurance application theme related information.
